(19) United States
(12) Patent Application Publication
(10) Pub. No.: US 2013/0278931 A1
(43) Pub. Date: Oct. 24, 2013

(54) SAMPLE RECEIVING APPARATUS

(71) Applicant: Morteza Bahrami, St. Albans (GB)

(72) Inventor: Morteza Bahrami, St. Albans (GB)

(21) Appl. No.: 13/993,768

(22) PCT Filed: Dec. 13, 2011
(86) PCT No.: PCT/GB11/01718

§ 371 Date: Jun. 13, 2013

(30) Foreign Application Priority Data
Dec. 14, 2010 (GB) 1021175.3

(51) Int. Cl. G01J 3/02

(52) U.S. Cl. CPC G01J 3/0267
USPC 356/319; 356/246

(57) ABSTRACT

Sample receiving apparatus (301) for use in, and a method of, retaining a liquid sample (305) to be analysed within a light path between a light source and a light detector. A sample receiving body (302) defines a sample duct (303) and a port (304) for allowing passage of a liquid sample (305) into the sample duct (303). The sample duct is configured to receive a liquid sample (305) between a light source input position (306) and a light detector input position (307), the distance between the light source input position and the light detector input position defining a sample path length (L). The sample receiving apparatus (301) is configured such that the distance between the light source input position (306) and the light detector input position (307) is adjustable so as to adjust the length of the sample path length (L). Sample receiving apparatus (301) for use in spectrophotometer. Sample receiving apparatus for use with low volume samples (305).

### FIELD OF THE INVENTION

The present invention relates to sample receiving apparatus for, and a method of, retaining a liquid sample to be analysed within a light path between a spectrophotometric source and a spectrophotometric detector.

### BACKGROUND TO THE INVENTION

Spectrophotometry is a branch of spectroscopy and is the quantitative measurement of the reflection or transmission of radiant energy by a material as a function of wavelength. A spectrophotometer comprises a light source and a light detector. A sample to be analysed is located within a light path between the light source and the light detector, and the spectrophotometer measures light intensity as a function of the light source wavelength. A 1 cm light path industry standard is known.

There are different types of spectrophotometer that are configured for use with a particular region of the electromagnetic spectrum, for example, ultraviolet, visible, and infrared. Spectrophotometers are used in many fields, including the fields of physics, chemistry and biochemistry.

It is known for a sample to be analysed to be presented in a cuvette. It is known for a cuvette to be fabricated from glass, plastic or quartz. A problem exists in that impurities or defects in the material of the cuvette can affect the measurements made by the spectrophotometer. In addition, use of cuvettes adds to the cost of the use of the spectrophotometer

It is known for a spectrophotometer to be used to analyse a liquid sample. The liquid sample may be a solution. A problem exists in that it is difficult to provide a suitable cuvette for a liquid sample of a relatively very small volume, for example of 2.0 μl or less.

It is desirable for a technique to be used for retaining a liquid sample within a light path between a light source and a light detector that does not interfere with the sample path length.

### SUMMARY OF THE INVENTION

According to a first aspect there is provided sample receiving apparatus for use in retaining a liquid sample to be analysed within a light path between a spectrophotometric source and a spectrophotometric detector, said sample receiving apparatus comprising: a sample receiving body defining a sample duct and a port for allowing passage of a liquid sample into said sample duct, said sample duct configured to receive a liquid sample between a light source input position and a light detector input position, the distance between said light source input position and said light detector input position defining a sample path length, and said sample receiving apparatus configured such that the distance between said light source input position and said light detector input position is adjustable so as to adjust the length of said sample path length.

In an embodiment, the port is configured to allow passage of a liquid sample from the sample duct.

In an embodiment, the sample receiving apparatus is configured to provide a sample path length in the range between 0.1 mm and 10 mm inclusive. In an embodiment, the sample receiving apparatus is configured for use with a sample volume in the range between 0.02 μl and 2.0 μl inclusive.

In an embodiment, the sample receiving body further defines a wash port configured to allow passage of a wash liquid into the sample duct.

According to a second aspect there is provided a method of retaining a liquid sample to be analysed within a light path between a light source and a light detector, said method comprising the steps of: receiving sample receiving apparatus comprising a sample receiving body defining a sample duct extending between a light input end and a light output end and a port for allowing passage of a liquid sample into said sample duct, and comprising a light detector member presenting a light input face movably located within said sample duct; locating said light input end of said sample receiving body against a light source delivery face of a light source delivery element such that said light path extends through said sample duct; introducing a liquid sample into said port; and, moving said light detector member along said sample duct.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 shows a schematic of a sample receiving apparatus in use;

FIG. 2 shows Beer's law;

FIG. 3 illustrates features of sample receiving apparatus according to a first specific example;

FIG. 4 shows further features of sample receiving apparatus according to the specific example;

FIG. 5 shows the sample receiving body and the light detector member of sample receiving apparatus according to the specific example in further detail;

FIG. 6 shows the sample receiving apparatus according to the specific example arranged for use;

FIG. 7 shows the sample receiving apparatus according to the specific example following full insertion of the light detector member into the sample receiving body, ready to receive a liquid sample;

FIG. 8 shows the scenario of FIG. 7, following withdrawal of the light detector member from within the sample receiving body to introduce a liquid sample into the sample receiving body for analysis;

FIG. 9 shows the scenario of FIG. 8, following analysis of the liquid sample within the sample receiving body;

FIG. 10 shows the scenario of FIG. 9, following full insertion of the light detector member into the sample receiving body;

FIG. 11 shows further features of the sample receiving apparatus according to the specific example;

FIG. 12 shows yet further features of the sample receiving apparatus according to the specific example;

FIGS. 13 & 14 show an optional feature of a sample receiving apparatus according to the specific example; and

FIG. 15 shows a sample receiving apparatus having features as described herein.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

FIG. 1

FIG. 1 shows a schematic of a sample receiving apparatus in use. Sample receiving apparatus 101 comprises a sample receiving body 102 for retaining a liquid sample, indicated at 103, in an arrangement in which the liquid sample 103 is located in a light path between a light source 104 and a light detector 105. In the shown arrangement, a light path passing from light source 104 to light detector 105, in the direction indicated by arrow 106, passes through the received liquid sample 103. The distance that the light path travels through the liquid sample 103 is the path length L.

In the arrangement shown in this Figure, the sample path length L is defined between light source input position 107 and light detector input position 108, along the direction of the light path. As shown in this Figure, in this illustrated arrangement, the light source 104 and the light detector 105 each present a substantially planar surface, between which the sample receiving body 102 is disposed. The facing substantially planar surfaces of the light source 104 and light detector 105 extend parallel to one another, and the light path L extends perpendicularly to each parallel plane.

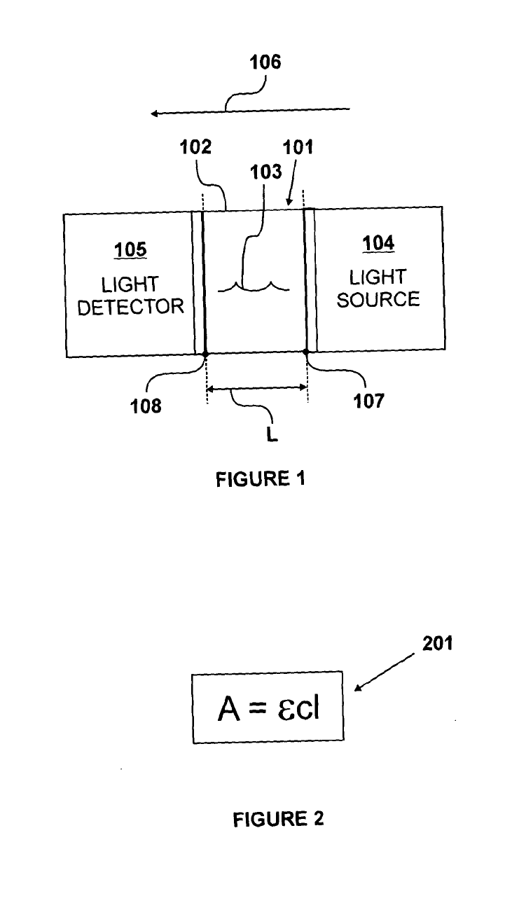

FIG. 2

FIG. 2 shows Beer's law at 201. Beer's law (also known as the Beer-Lambert law or the Beer-Lambert-Bouguer law) states that the absorption of light by an absorbing substance in a sample is proportional to the concentration of the absorbing substance in the sample and the sample path length. As shown in FIG. 2, Beer's law is stated as A=εcl, where A is absorbance, c is concentration in mol L⁻¹, l is the sample path length in cm and ε is molar absorptivity in L cm⁻¹. Clearly, from Beer's law, it is important for the sample path length to be determined as accurately as possible.

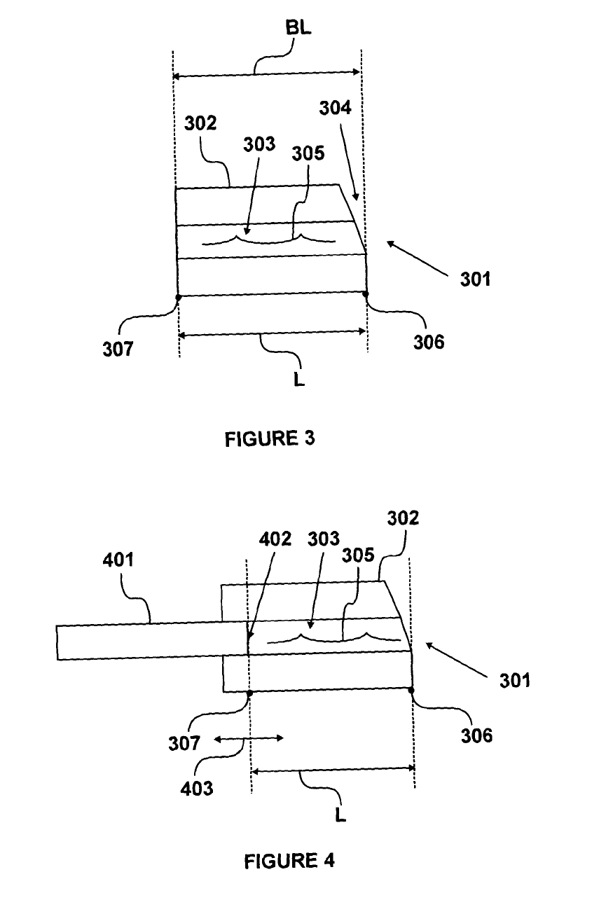

FIG. 3

FIG. 3 shows features of a sample receiving apparatus 301, for use in retaining a liquid sample within a light path between a spectrophotometric source and a spectrophotometric detector, according to a specific example. Sample receiving apparatus 301 comprises a sample receiving body 302. The sample receiving body 302 defines a sample duct, indicated at 303, and a port, indicated at 304, for allowing passage of a liquid sample, indicated at 305, into the sample duct 303. In this specific example, the port 304 also allows passage of the liquid sample 305 from the sample duct 303. The sample duct 303 is configured to receive a liquid sample 305 between a light source input position 306 and a light detector input position 307, the distance between the light source input position 306 and the light detector input position 307 defining a sample path length L. As will be described in further detail below, sample receiving apparatus 301 is configured such that the distance between light source input position 306 and light detector input position 307 is adjustable so as to adjust the length of sample path length L.

FIG. 4

FIG. 4 shows further features of sample receiving apparatus 301.

Sample receiving body 302 defines a fixed light source input position 306. The sample receiving apparatus 301 further comprises a light detector member 401 presenting a light input face 402. Light detector member 401 is movably receivable within the sample duct 303 of sample receiving body 302 so as to locate the light input face 402 within the sample duct 303 such that the light detector input position 307 is the position of the light input face 402 within the sample duct 303, and the light input face 402 is movable relative to the light source input position 306, as indicated by arrow 403, so as to adjust the magnitude of the sample path length L. According to the present specific example, the sample receiving apparatus 301 is configured to allow the light input face 402 of light detector member 401 to be moved to and from the light source input position 306. According to this specific example, the maximum available sample path length is the length of the sample receiving body, indicated by arrow BL.

Thus, the sample receiving apparatus 301 allows the sample path length L to be varied within an available sample path length range. This feature is advantageous for use of the sample receiving apparatus with samples of different volumes.

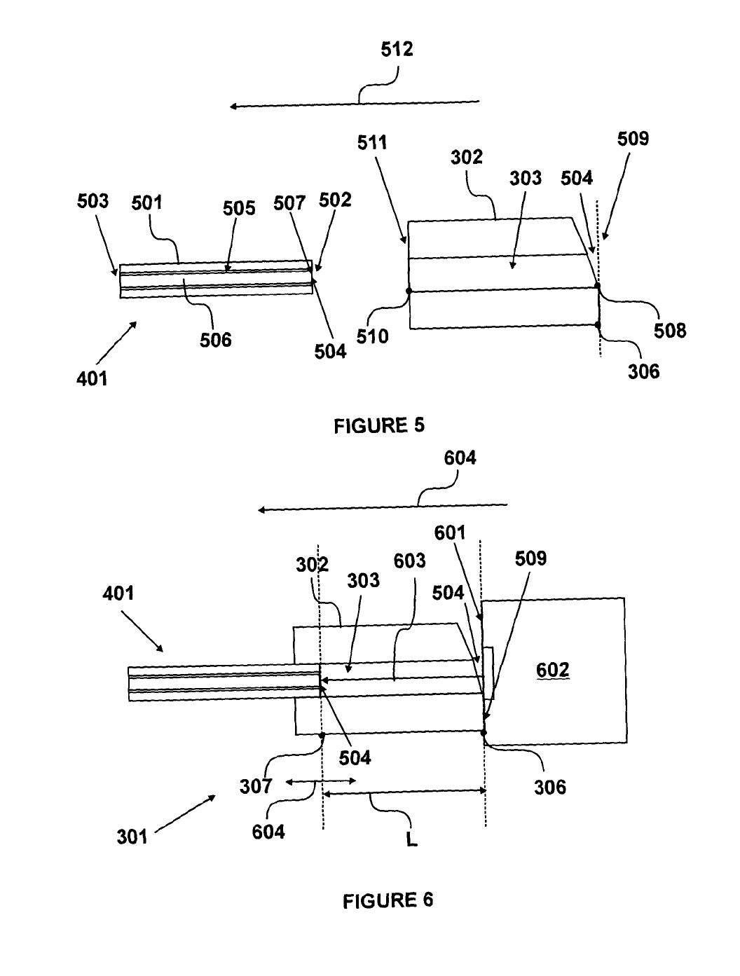

FIG. 5

FIG. 5 shows the sample receiving body 302 and the light detector member of the sample receiving apparatus of the present specific example in further detail. In FIG. 5, the sample receiving body 302 and the light detector member 401 are shown separated from one another.

Light detector member 401 comprises an elongate body 501 having a leading end 502 and a trailing end 503. The leading end 503 of the elongate body 501 defines a light input aperture, indicated at 504. The elongate body 501 defines an internal bore 505 extending from the light input aperture 504. In this example, the sample duct 303 of the sample receiving body 302 is cylindrical. The elongate body 501 is a tube configured to receive an optical fibre element 506 within a central internal bore 505 such that a light input end 507 of the optical fibre element 506 is present within a circular light input aperture 504. Light received by the optical fibre element 506 is input to an analyser.

The sample duct 303 of sample receiving body 302 extends through the sample receiving body 302 between an input end point 508 open at a light input end 509 of the sample receiving body 302 and an output end point 510 open at a light output end 511 of the sample receiving body 302. As shown, the light source input position 306 is at the position of the input end point 508 of the sample duct 303. The light input end 509 of the sample receiving body 302 is configured for abutment against a light source delivery face of a light source delivery element.

In this Figure, the direction from the light input end 509 to the light output end 511 of the sample receiving body 302 and the leading end 502 to the trailing end 503 of light detector member 401 is indicated by arrow 512.

As can be seen in this Figure, port 504 is provided by a sloping end face portion at the light input end 509 of the sample receiving body 302, which slopes away from input end point 508 towards light output end 511.

FIG. 6

FIG. 6 shows the sample receiving apparatus of the present specific example arranged for use. In an application, and as shown in this Figure, the sample receiving body is oriented horizontally.

The sample receiving body 302 is shown with the light input end 509 abutting against light source delivery face 601 of light source delivery element 602. The sample receiving body 302 is located relative to light source delivery element 602 such that light from light source delivery element 602, indicated by arrow 603, passes from light source delivery face 601, through sample duct 303 to light input aperture 504 of light detector member 401, in the direction indicated by arrow 603.

As previously stated, the sample path length L is defined between light source input position 306 and light detector input position 307. The light detector input position 307 is movable relative to the light source input position 306, as indicated by arrow 604, so as to adjust the magnitude of the sample path length L.

When in the abutting condition as shown in this Figure, light source delivery face 601 of light source delivery element 602, in effect, provides a wall for port 504.

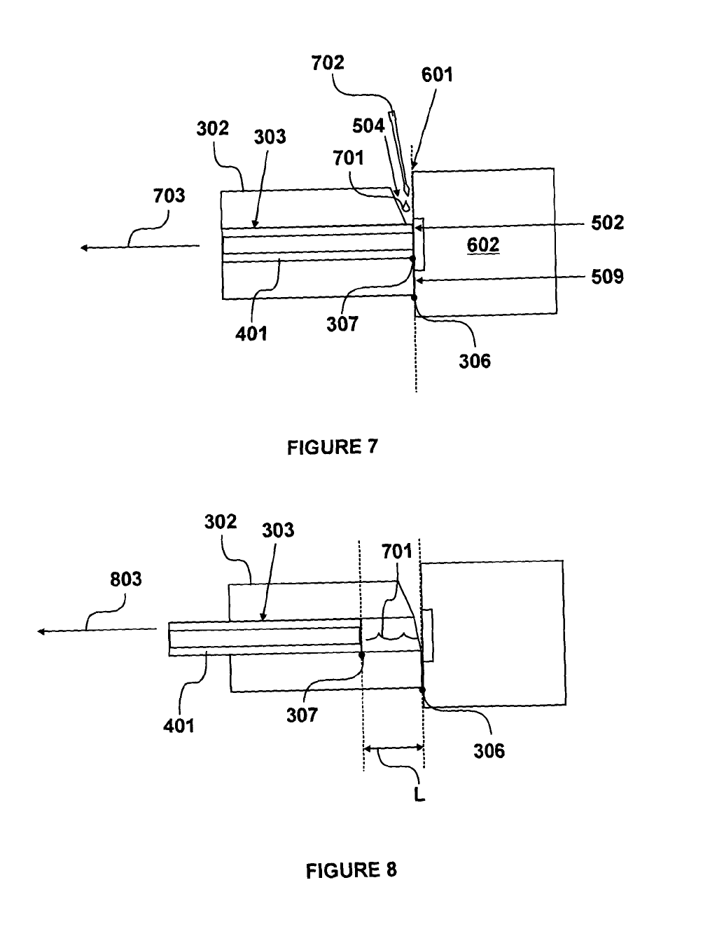

FIG. 7

FIG. 7 shows the sample receiving apparatus of the present specific example arranged for use, ready to receive a liquid sample,

Sample receiving body 302 is shown with the light input end 509 abutting against light source delivery face 601 of light source delivery element 602. Light detector member 401 is fully inserted inside sample duct 303 of the sample receiving body 302, such that leading end 502 is also abutting against light source delivery face 601 of light source delivery element 602. As shown, in this arrangement, the light detector input position 307 is at the same position as the light source input position 306.

A liquid sample, indicated at 701, may now be introduced into port 504. In this illustrated scenario, liquid sample 701 is being dispensed from a pipette 702.

The light detector member 401 may now be drawn from the sample duct 303 of the sample receiving body 302, in the direction indicated by arrow 703. This action will draw liquid in port 504 into the sample duct 303 of the sample receiving body 302.

FIG. 8

FIG. 8 shows the scenario of FIG. 7 following withdrawal of light detector member 401 from the sample duct 303 of the sample receiving body 302. The action of moving the light detector member 401 in the direction indicated by arrow 803, has caused the light detector input position 307 to have moved away from the light source input position 306. This has resulted in the liquid sample 701 having been drawn into the sample duct 303 of the sample receiving body 302, and simultaneously the definition of sample path length L. With the sample path length L at the desired magnitude, the sample may now be analysed.

Thus, a method of retaining a liquid sample within a light path between a light source and a light detector comprises the steps of: receiving sample receiving apparatus comprising a sample receiving body defining a sample duct extending between a light input end and a light output end and a port for allowing passage of a liquid sample into the sample duct, and comprising a light detector member presenting a light input face movably located within the sample duct; locating the light input end of the sample receiving body against a light source delivery face of a light source delivery element such that the light path extends through the sample duct; introducing a liquid sample into the port; and, moving the light detector member along the sample duct.

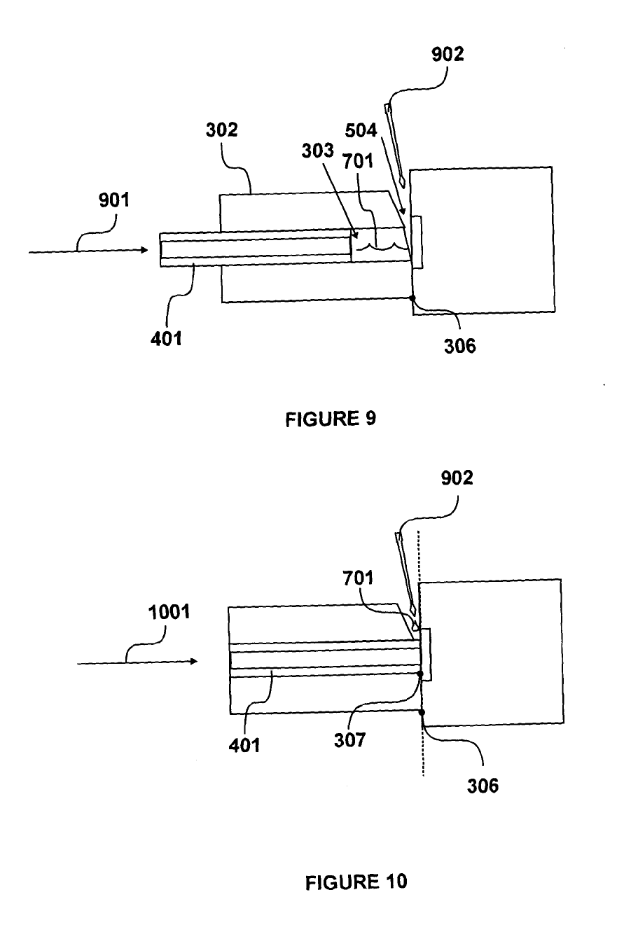

FIG. 9

FIG. 9 shows the scenario of FIG. 8 following analysis of the sample 701. The light detector member 401 may now be moved in the direction indicated by arrow 901, further into sample duct 303 of sample receiving body 302. This action will push the liquid sample 701 in the sample duct 303 of the sample receiving body 302 into port 504. The liquid sample 701 may be removed from the port 504 by a pipette 902.

FIG. 10

FIG. 10 shows the scenario of FIG. 9 following movement of the light detector member 401 in the direction indicated by arrow 1001. In this Figure, the light detector member 401 is shown having been fully inserted again into the sample duct 303 of the sample receiving body 302, such that the light detector input position 307 is at the same position as the light source input position 306, as in the arrangement of the starting position shown in FIG. 7.

As mentioned with reference to FIG. 9, any liquid sample 701 present in port 504 may be removed from the port 504 by a pipette 902.

Thus, the sample receiving apparatus allows a liquid sample to be recovered following analysis. This feature is advantageous for allowing a sample that is not readily obtainable to be reused. It is to be appreciated that the availability of a sample may be limited or that a sample may be very expensive.

Advantageously, the sample receiving apparatus negates the requirement for use of a cuvette.

In an embodiment, the light detector member 401 is fabricated from stainless steel tube. In an example, the light detector member 401 is fabricated from stainless steel tube having an external diameter of approximately 0.5 mm. In an embodiment, the sample receiving body 302 defines a cylindrical sample duct 303. In an example, the sample receiving body 302 defines a cylindrical sample duct 303 having a diameter of approximately 0.5 mm. In an example, the light detector member 401 is fabricated from stainless steel tube having an external diameter of approximately 0.5 mm and the sample duct 303 of the sample receiving body 302 defines a cylindrical sample duct 303 having a diameter of approximately 0.5 mm.

In an embodiment, the sample receiving body 302 is fabricated from polytetrafluoroethylene (PTFE) or fluorinated ethylene propylene (FEP). These materials have a degree of resilience. In an example, the sample receiving body 302 is fabricated from polytetrafluoroethylene (PTFE) or fluorinated ethylene propylene (FEP) and defines a cylindrical sample duct 303 having a diameter of slightly smaller than 0.5 mm, and the light detector member 401 is fabricated from stainless steel tube having an external diameter of 0.5 mm. The compressible property of either of these materials allows the light detector member 401 to be received within the sample duct 303 of the sample receiving body 302 with an interference fit, which advantageously creates a seal between the light detector member 401 and sample receiving body 302, to assist retention of a liquid sample.

In addition, polytetrafluoroethylene (PTFE) and fluorinated ethylene propylene (FEP) each exhibit an advantageous property of resistance against the attachment of a protein sample thereto.

FIG. 11

FIG. 11 shows further features of sample receiving apparatus 301. The sample receiving apparatus 301 comprises a light detector member actuator 1101 for moving light detector member 401 within the sample duct 303 of sample receiving body 302. A motorised light detector member actuator is advantageous for fine adjustments. A light detector member actuator facilitates control of the light detector member.

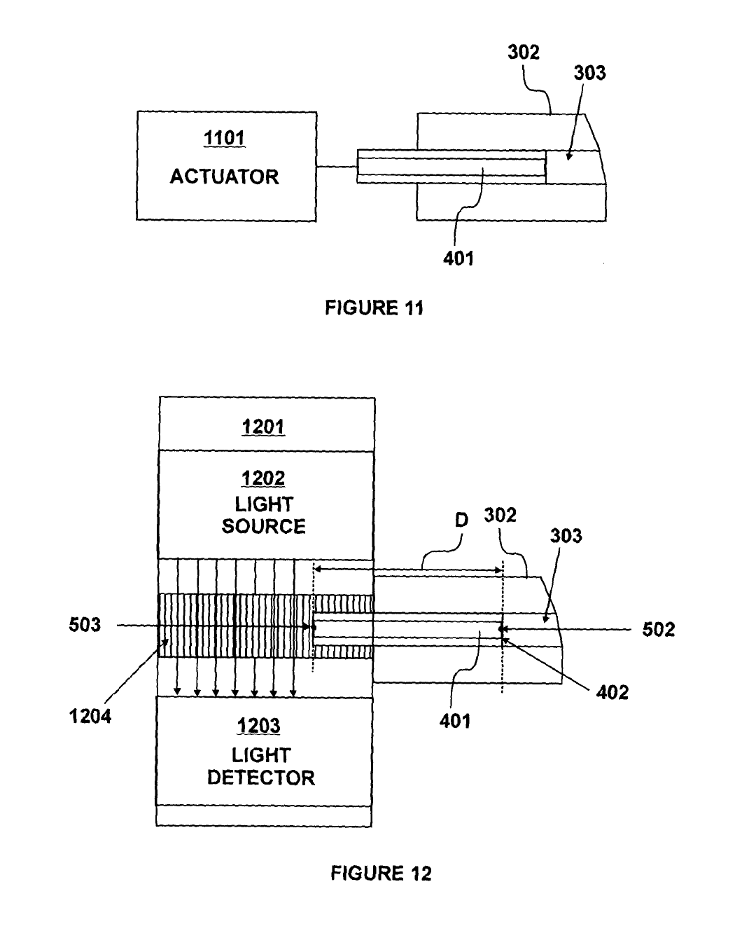

FIG. 12

FIG. 12 shows yet further features of sample receiving apparatus 301. The sample receiving apparatus 301 comprises a light detector member position indicator 1201 for indicating the position of the light input face 402 of said light detector member 401 within the sample duct 303 of sample receiving body 302.

According to this example, the light detector member position indicator 1201 a light source 1202 and a light detector 1203 configured to provide a linear detection zone therebetween, indicated at 1204, and configured to detect the position of the trailing end 503 of the light detector member 401 within the linear detection zone 1204. On the basis that the distance D between the leading end 502 and the trailing end 503 of the light detector member 401 is known, the position of the leading end 502 of the light detector member 401 can be calculated once the position of the trailing end 503 of the light detector member 401 is known.

In an example, the light source 1202 of the light detector member position indicator 1201 comprises a light emitting diode lamp. In an example, the light detector 1203 of the light detector member position indicator 1201 comprises a linear CCD or diode array detector, having 1024 or 2048 pixels. The position accuracy is then determined by the pixel size. This feature of the sample receiving apparatus advantageously allows for improved accuracy of determination of the sample path length. In a specific example, the light detector 1203 is accurate to 10 μm.

In an embodiment, the sample receiving apparatus is configured to provide a sample path length in the range between 0.1 mm and 10 mm inclusive. In an embodiment, the sample receiving apparatus is configured for use with a sample volume in the range between 0.02 μl and 2.0 μl inclusive. Thus, the sample receiving apparatus advantageously allows for analysis of low volume samples.

It is to be appreciated that sample receiving apparatus as described herein may be used with any type of spectrophotometer, for example an ultraviolet, visible, or infrared spectrophotometer. It is to be understood that the sample receiving apparatus may advantageously be used with existing spectrophotometers. It is to be further appreciated that sample receiving apparatus as described herein may be used with any type of light source and light detector suitable for analysis of a received liquid sample.

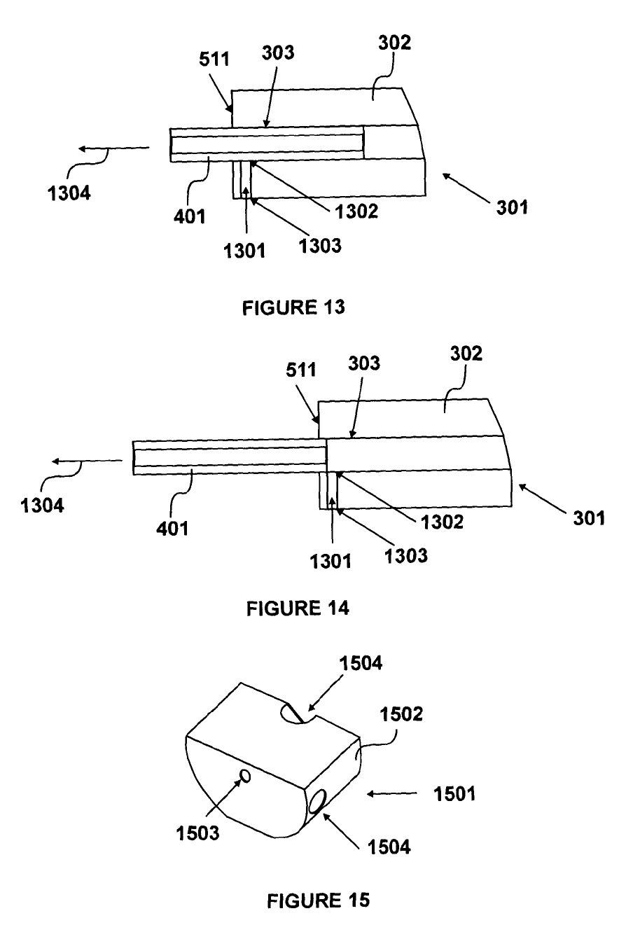

FIGS. 13 & 14

An optional feature of sample receiving apparatus 301 is shown in FIGS. 13 and 14. As illustrated, the sample receiving body 302 further defines a wash duct, indicated at 1301, having a wash outlet port, indicated at 1302, open to the sample duct 303. The wash duct 1301 allows wash liquid (not shown) to be introduced into the sample duct 303 for the purpose of cleaning the sample duct. This feature allows the sample duct 303 to be washed for reuse of the sample receiving body 302. This feature is particularly advantageous when the sample receiving apparatus 301 is being used with sticky samples. In this illustrated example, the wash duct 1301 has a wash inlet port, indicated at 1303, that is open to an outer surface of the sample receiving body 302. According to the illustrated arrangement, the wash duct 1301 extends substantially perpendicularly to the length direction L of the sample duct 303.

As shown, the wash duct 1301 is located towards the light output end 511 of the sample receiving body 302, such that the light detector member 401 blocks the wash outlet port 1302 (as shown in FIG. 13) until the light detector member 401 has been moved a sufficient distance in the direction indicated by arrow 1304 for the wash outlet port 1302 to be exposed (as shown in FIG. 14).

Any suitable wash liquid may be used, and any suitable apparatus for, and method of, using the wash liquid to clean the sample duct of the sample receiving body may be utilised. In an example, a wash liquid pump is provided for effecting flow of wash liquid through the wash duct and sample duct.

FIG. 15

FIG. 15 shows a sample receiving apparatus 1501, for use in retaining a liquid sample within a light path between a spectrophotometric source and a spectrophotometric detector, according to a specific example. Sample receiving apparatus 1501 comprises a sample receiving body 1502 that defines a sample duct, indicated at 1503, extending through the sample receiving body 1502, and a port, indicated at 1504, at one end of the sample receiving body 1502, for allowing passage of a liquid sample into the sample duct 1503. The sample receiving body 1502 further defines a wash duct, indicated at 1505, for allowing passage of a wash liquid into the sample duct 1503.

It is to be appreciated that a sample receiving apparatus as described herein allows for a liquid sample to be held for analysis within a light path between a spectrophotometric source and a spectrophotometric detector and allows for that liquid sample to be recovered. It is to be appreciated that a sample receiving apparatus as described herein allows for a light detector member received within a sample receiving duct to be moved to control inflow and outflow of liquid sample along a light path between a spectrophotometric source and a spectrophotometric detector.

1. A sample receiving apparatus for retaining a liquid sample to be analysed within a light path between a spectrophotometric source and a spectrophotometric detector, said sample receiving apparatus comprising:
a sample receiving body defining a sample duct and a port for allowing passage of a liquid sample into said sample duct;
said sample duct configured to receive a liquid sample between a light source input position and a light detector input position, the distance between said light source input position and said light detector input position defining a sample path length; and
said sample receiving apparatus configured such that the distance between said light source input position and said light detector input position is adjustable so as to adjust the length of said sample path length.

2. The sample receiving apparatus of claim 1, wherein said port is configured to allow passage of a liquid sample from said sample duct.

3. The sample receiving apparatus of claim 1, wherein:
said sample receiving body defines a fixed light source input position, said sample receiving apparatus further comprises a light detector member presenting a light input face; and
said light detector member is movably receivable within said sample duct of said sample receiving body so as to locate said light input face within said sample duct such that:
said light detector input position is the position of said light input face within said sample duct, and
said light input face is movable relative to said light source input position so as to adjust the magnitude of said sample path length.

4. The sample receiving apparatus of claim 3, configured to allow said light input face of said light detector member to be moved to and from said light source input position.

5. The sample receiving apparatus of claim 3, wherein said light detector member comprises
an elongate body having a leading end and a trailing end;
the leading end of said elongate body defines a light input aperture;
said elongate body defines an internal bore extending from said light input aperture; and
said elongate body is configured to receive an optical fibre element within said internal bore such that a light input end of said optical fibre element is present within said light input aperture.

6. The sample receiving apparatus of claim 5, wherein said sample duct extends through said sample receiving body between an input end point open at a light input end of said sample receiving body and an output end point open at a light output end of said sample receiving body.

7. The sample receiving apparatus of claim 6, wherein said light source input position is said input end point of said sample duct.

8. The sample receiving apparatus of claim 7, wherein said light input end of said sample receiving body is configured for abutment against a light source delivery face of a light source delivery element.

9. The sample receiving apparatus of claim 3, further comprising a light detector member actuator for moving said light detector member within said sample duct of said sample receiving body.

10. The sample receiving apparatus of claim 3, further comprising a light detector member position indicator for indicating the position of said light input face of said light detector member within said sample duct.

11. The sample receiving apparatus of claim 10, wherein said light detector member position indicator comprises:
a light source and a light detector configured to provide a linear detection zone therebetween, and configured to detect the position of said trailing end of said light detector member within said linear detection zone.

12. The sample receiving apparatus of claim 11, wherein said light source of said light detector member position indicator comprises a light emitting diode lamp.

13. The sample receiving apparatus of claim 11, wherein said light detector of said light detector member position indicator comprises a linear CCD array detector.

14. The sample receiving apparatus of claim 1, configured to provide a sample path length in the range between 0.1 mm and 10 mm inclusive.

15. The sample receiving apparatus of claim 1, configured for use with a sample volume in the range between 0.02 μl and 2.0 μl inclusive.

16. The sample receiving apparatus of claim 1, wherein said sample receiving body further defines a wash port configured to allow passage of a wash liquid into said sample duct.

17. A method of retaining a liquid sample to be analysed within a light path between a light source and a light detector, said method comprising the steps of:
receiving sample receiving apparatus comprising a sample receiving body defining a sample duct extending between a light input end and a light output end and a port for allowing passage of a liquid sample into said sample duct, and comprising a light detector member presenting a light input face movably located within said sample duct;
locating said light input end of said sample receiving body against a light source delivery face of a light source delivery element such that said light path extends through said sample duct;
introducing a liquid sample into said port; and,
moving said light detector member along said sample duct away from said light source delivery face of said light source delivery element to draw liquid sample introduced into said port from said port into sample duct.

18. The method of claim 17, further comprising the step of:
moving said light detector member along said sample duct towards said light source delivery face of said light source delivery element to push liquid sample drawn into said sample duct from said port back into said port.

19-20. (canceled)
